(19) United States
(12) Patent Application Publication
(10) Pub. No.: US 2026/0302808 A1
(43) Pub. Date: Oct. 1, 2026

(54) CHARGE/DISCHARGE CONTROL CIRCUIT, CHARGE/DISCHARGE CONTROL DEVICE, BATTERY DEVICE, AND BATTERY SYSTEM

(71) Applicant: ABLIC Inc., Nagano (JP)

(72) Inventors: Daichi Yamashita, Nagano (JP); Sho HOSHINO, Nagano (JP); Fumihiko MAETANI, Nagano (JP)

(73) Assignee: ABLIC Inc., Nagano (JP)

(21) Appl. No.: 19/530,409

(22) Filed: Feb. 5, 2026

(30) Foreign Application Priority Data
Mar. 25, 2025 (JP) 2025-050174

(51) Int. Cl. H02J 7/62; H02J 7/00; H02J 7/80; H02J 7/94

(52) U.S. Cl. CPC H02J 7/62; H02J 7/80; H02J 7/855; H02J 7/94

(57) ABSTRACT

A charge/discharge control circuit includes a control circuit configured to transition to a control state corresponding to a detection result of an abnormal state and perform open/close control of a charge/discharge path of one or a plurality of secondary batteries being a control target in accordance with the control state. The charge/discharge control circuit is connected in parallel to an external terminal provided in the charge/discharge path, and is configured to transmit and receive a detection result signal including the detection result to and from another charge/discharge control circuit having, as a control target, one or a plurality of secondary batteries different from the one or the plurality of secondary batteries of an own circuit, to thereby share the control state of the own circuit and the control state of the another charge/discharge control circuit.

### CROSS REFERENCE TO RELATED APPLICATIONS

This application claims the priority benefit of Japanese Patent Application No. 2025-050174, filed on Mar. 25, 2025. The entirety of the above-mentioned patent application is hereby incorporated by reference herein and made a part of this specification.

### BACKGROUND OF THE INVENTION

### 1. Field of the Invention

The present invention relates to a charge/discharge control circuit, a charge/discharge control device, a battery device, and a battery system.

### 2. Description of the Related Art

Hitherto, a protection IC for protecting a battery by controlling charge/discharge of the battery has been known (see Japanese Patent Application Laid-open No. 2012-257407).

In a case of constructing a battery management system including two batteries connected in parallel to an external terminal and two protection ICs for controlling the respective batteries, there are various problems with the above-mentioned protection IC. For example, in a case of using a related-art protection IC, it may be difficult to maintain a discharge prohibition state in a case in which only one protection IC detects a discharge overcurrent.

The related-art protection IC prohibits discharging by turning off a discharge control transistor in a case of detecting a discharge overcurrent. With the discharge current being interrupted by the discharge prohibition, a voltage of a VM terminal for detecting whether a charger or an abnormal load is connected to the external terminal increases, and the discharge overcurrent detection state is maintained.

However, in a case in which two protection ICs are connected in parallel to the external terminal, and one protection IC detects a discharge overcurrent but the other protection IC does not detect the discharge overcurrent, the voltage of the VM terminal cannot increase because the discharge of the other protection IC is not prohibited. Accordingly, the one protection IC repeats an operation of returning to a dischargeable state after the discharge prohibition and becoming the discharge prohibition state again, and it is difficult to appropriately protect the battery.

In addition, in a case in which only one protection IC detects an abnormal state and performs discharge prohibition or charge prohibition, the balance of voltages of the two batteries is lost, which may lead to a malfunction.

### SUMMARY OF THE INVENTION

The present invention has an object to provide a technology capable of suitably protecting a battery in a case of using two or more batteries and two or more protection ICs.

According to at least one aspect of the present invention, there is provided a charge/discharge control circuit including a control circuit configured to transition to a control state corresponding to a detection result of an abnormal state and perform open/close control of a charge/discharge path of one or a plurality of secondary batteries being a control target in accordance with the control state. The charge/discharge control circuit is connected in parallel to an external terminal provided in the charge/discharge path, and is configured to transmit and receive a detection result signal including the detection result to and from another charge/discharge control circuit having, as a control target, one or a plurality of secondary batteries different from the one or the plurality of secondary batteries of an own circuit, to thereby share the control state of the own circuit and the control state of the another charge/discharge control circuit.

According to the at least one aspect of the present invention, it is possible to suitably protect a battery in a case of using two or more batteries and two or more protection ICs.

### BRIEF DESCRIPTION OF THE DRAWINGS

FIG. 1 is an explanatory diagram for illustrating an example of a battery system according to a first embodiment of the present invention.

FIG. 2 is an explanatory diagram for illustrating a configuration example of a charge/discharge control circuit according to the first embodiment.

FIG. 3 is an explanatory diagram for illustrating a configuration example of a transmission circuit in the first embodiment.

FIG. 4 is an explanatory diagram for illustrating a configuration example of a reception circuit in the first embodiment.

FIG. 5 is an explanatory diagram for illustrating a configuration example of a charge/discharge control circuit according to a second embodiment of the present invention.

FIG. 6 is an explanatory diagram for illustrating a configuration example of a charge/discharge control circuit according to a third embodiment of the present invention.

FIG. 7 is an explanatory diagram for illustrating a configuration example of a charge/discharge control circuit according to a fourth embodiment of the present invention.

FIG. 8 is an explanatory diagram for illustrating a configuration example of a charge/discharge control circuit according to a fifth embodiment of the present invention.

FIG. 9 is an explanatory diagram for illustrating a configuration example of a charge/discharge control circuit according to a sixth embodiment of the present invention.

FIG. 10 is an explanatory diagram for illustrating a configuration example of a charge/discharge control circuit according to a seventh embodiment of the present invention.

### DESCRIPTION OF THE EMBODIMENTS

### First Embodiment

A charge/discharge control circuit, a charge/discharge control device, a battery device, and a battery system according to at least one embodiment of the present invention are described in detail below by means of preferred embodiments with reference to the attached drawings. In the description of the drawings, the same or similar parts are denoted by the same or similar reference symbols.

Throughout the drawings for illustrating the embodiments, components having the same function are denoted by the same reference symbols, and a duplicate description thereof is omitted. The description “based on XX” as used herein means “based on at least XX,” and encompasses a case of being “based on another element in addition to XX.” Further, the description “based on XX” is not limited to a case of directly using “XX” but encompasses a case of being “based on a result of calculating or processing XX.” The term “XX” refers to a freely selected element (for example, freely selected information). Now, with reference to the drawings, description is given of the embodiments of the present invention.

### Configuration Example of Battery System

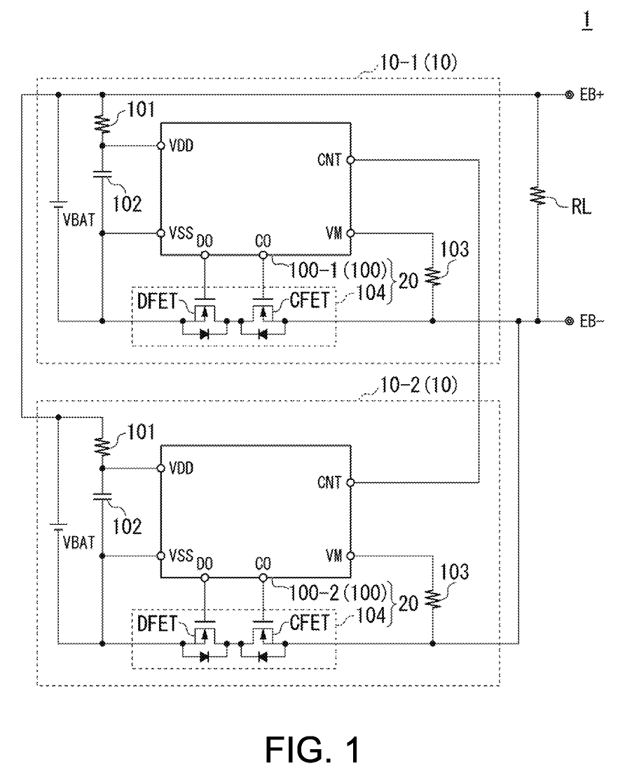

FIG. 1 is an explanatory diagram for illustrating an example of a battery system 1 according to a first embodiment of the present invention. The battery system 1 includes a plurality of battery devices 10 and a load resistor RL. A first battery device 10-1 and a second battery device 10-2 are examples of the plurality of battery devices 10. The battery system 1 is not limited to an example including two battery devices 10. The plurality of battery devices 10 are connected in parallel to an external positive electrode terminal EB+ and an external negative electrode terminal EB-. In the following description, the external positive electrode terminal EB+ and the external negative electrode terminal EB- may be collectively referred to as “external terminal.”

The battery device 10 includes a charge/discharge control circuit 100, a secondary battery VBAT, a resistor 101, a capacitor 102, a resistor 103, and an external FET 104. In some cases, the charge/discharge control circuit 100 included in the first battery device 10-1 is referred to as “first charge/discharge control circuit 100-1,” and the charge/discharge control circuit 100 included in the second battery device 10-2 is referred to as “second charge/discharge control circuit 100-2.” The first charge/discharge control circuit 100-1 and the second charge/discharge control circuit 100-2 have a similar configuration. In a case in which those circuits are not distinguished, the circuits are simply referred to as “charge/discharge control circuit 100,” and description is given of the charge/discharge control circuit 100. In the following description, in a case of describing a relationship between the plurality of charge/discharge control circuits 100, description is given assuming that the first charge/discharge control circuit 100-1 is an own circuit, and the second charge/discharge control circuit 100-2 is another circuit.

The charge/discharge control circuit 100 is an example of a circuit that operates based on a predetermined condition to, for example, control charge/discharge of the secondary battery VBAT, to thereby protect the secondary battery VBAT from an abnormal state such as a discharge overcurrent. The charge/discharge control circuit 100 includes, for example, a VDD terminal, a VSS terminal, a DO terminal, a CO terminal, a VM terminal, and a CNT terminal. The charge/discharge control circuit 100 may be referred to as, for example, “protection IC.” Although an example in which the number of secondary batteries VBAT to be controlled by the charge/discharge control circuit 100 is one is illustrated, the charge/discharge control circuit 100 may control a plurality of secondary batteries VBAT. The secondary batteries VBAT being control targets of the respective charge/discharge control circuits 100 are different from each other.

The VDD terminal is a terminal connected to a power supply outside the charge/discharge control circuit 100 (also referred to as “positive electrode power supply terminal”). The VDD terminal is, for example, a terminal to be connected to a positive electrode of the secondary battery VBAT. The VSS terminal is, for example, a terminal to be connected to a negative electrode of the secondary battery VBAT (also referred to as “negative electrode power supply terminal”). A voltage is supplied from the VDD terminal for an operation of the charge/discharge control circuit 100. The DO terminal and the CO terminal are connected to the external FET 104. The CO terminal may be referred to as “charge control terminal.” The DO terminal may be referred to as “discharge control terminal.” The VM terminal is an external negative voltage input terminal for detecting whether a charger (not shown) is connected to the external terminal. The CNT terminal is connected to a CNT terminal of another charge/discharge control circuit 100 via a signal line.

The secondary battery VBAT includes a positive electrode connected to one end of the resistor 101, one end of the load resistor RL, and the external positive electrode terminal EB+, and a negative electrode connected to one end of the capacitor 102, the VSS terminal, and a source of a discharge control transistor DFET. Specific examples of the secondary battery VBAT include a lithium ion battery and a lead storage battery. The secondary battery VBAT may be referred to as “battery.”

Another end of the resistor 101 is connected to the VDD terminal and another end of the capacitor 102. The capacitor 102 includes the one end connected to the VSS terminal, and the another end connected to the VDD terminal. The resistor 103 includes one end connected to the VM terminal, and another end connected to a source of a charge control transistor CFET, another end of the load resistor RL, and the external negative electrode terminal EB-.

The external FET 104 includes the discharge control transistor DFET and the charge control transistor CFET. In the following, in some cases, the charge/discharge control circuit 100 and the external FET 104 are collectively referred to as “charge/discharge control device 20.” The discharge control transistor DFET includes a gate connected to the DO terminal of the charge/discharge control circuit 100, and a source and a drain connected to a charge/discharge path of the secondary battery VBAT. For example, a discharge current of the secondary battery VBAT is interrupted in a case in which a control signal is supplied to the gate and the discharge control transistor DFET is turned off. The charge control transistor CFET includes a gate connected to the CO terminal of the charge/discharge control circuit 100 similarly to the discharge control transistor DFET, and a control signal is supplied to the charge control transistor CFET. A source and a drain of the charge control transistor CFET are connected to the charge/discharge path of the secondary battery VBAT. For example, a charge current of the secondary battery VBAT is interrupted in a case in which the charge control transistor CFET is turned off. As described above, the external FET 104 controls the charge/discharge path of the secondary battery VBAT by the charge control transistor CFET and the discharge control transistor DFET provided in the charge/discharge path.

### Configuration Example of Charge/Discharge Control Circuit

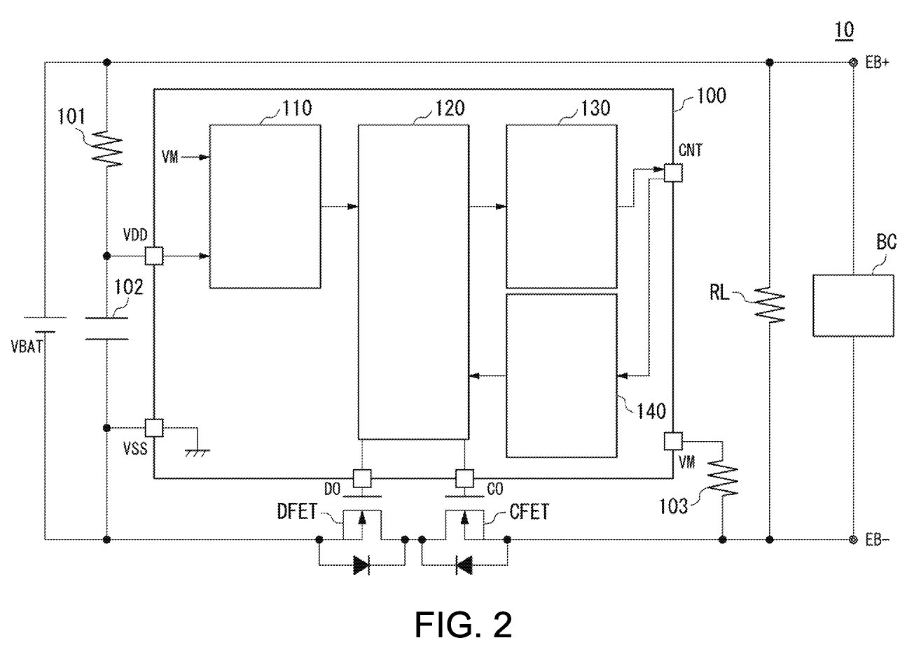

FIG. 2 is an explanatory diagram for illustrating a configuration example of the charge/discharge control circuit 100 according to the first embodiment. The charge/discharge control circuit 100 includes an abnormality detection circuit 110, a control circuit 120, a transmission circuit 130, and a reception circuit 140. The VSS terminal is connected to, for example, a reference voltage. The reference voltage may be 0 V, a small voltage close to 0 V, or any other voltage. FIG. 2 shows an example in which a charger BC is connected to the external terminal.

The abnormality detection circuit 110 detects an abnormal state related to the secondary battery VBAT such as overcharge, overdischarge, and discharge overcurrent. The abnormality detection circuit 110 collectively shows circuits for detecting respective abnormal states, and is implemented by, for example, various detection circuits such as an overcharge detection circuit, an overdischarge detection circuit, and a discharge overcurrent detection circuit. The number of types of abnormal states to be detected by the abnormality detection circuit 110 may be one or a plurality. For example, the abnormality detection circuit 110 includes a first input end connected to the VM terminal and a second input end connected to the VDD terminal, and determines an abnormal state by voltages supplied from those terminals. An output end of the abnormality detection circuit 110 is connected to the control circuit 120. The abnormality detection circuit 110 detects whether an abnormal state has occurred, and provides a signal including a detection result to the control circuit 120. The detection result includes presence or absence of detection of an abnormal state, a type of the detected abnormal state, and the like. The abnormality detection circuit 110 may or may not coordinate outputs of various detection circuits (not shown). In a case in which the abnormality detection circuit 110 does not coordinate the outputs, signals provided from the respective detection circuits may be collectively referred to as “detection result signal.” Further, in the detection result signal, a signal including a result in which a detection target is detected (for example, a high-level signal) may be referred to as “detection signal,” and a signal including a result in which the detection target is not detected (for example, a low-level signal) may be referred to as “cancellation signal.”

The control circuit 120 includes a first end connected to the output end of the abnormality detection circuit 110, a second end connected to the DO terminal, a third end connected to the CO terminal, a fourth end connected to the transmission circuit 130, and a fifth end connected to the reception circuit 140.

The detection result signal is supplied from the abnormality detection circuit 110 to the first end of the control circuit 120. The control circuit 120 maintains or transitions a control state in accordance with the detection result. The control state includes a normal state and a protection state. The normal state is a state in which an abnormal state is not detected. The protection state is a state in which an abnormal state is detected. The control circuit 120 responds to the detected abnormal state by supplying a control signal corresponding to the control state to the external FET 104 via the second end and the third end to perform open/close control of the charge/discharge path of the secondary battery VBAT. Further, the control circuit 120 controls the transmission circuit 130 by providing a control signal from the fourth end.

The detection result signal is supplied from the reception circuit 140 to the fifth end of the control circuit 120. The control circuit 120 maintains or transitions the control state similarly to the case in which the detection result signal is supplied from the abnormality detection circuit 110. In a case in which the detection signal supplied from the abnormality detection circuit 110 and the detection signal supplied from the reception circuit 140 indicate detection of different types of abnormal states, there is a possibility that the control state of the control circuit 120 is not stable. Accordingly, the charge/discharge control circuit 100 may have a configuration in which the detection signal is not supplied from the reception circuit 140 at the time of detection of an abnormal state by the abnormality detection circuit 110. The phrase “the detection signal is not supplied from the reception circuit 140” may mean, for example, that the detection result signal is not supplied, or that the cancellation signal is supplied regardless of the detection result received by the reception circuit 140. The control circuit 120 may maintain or transition the control state in accordance with the detection signal from any one of the abnormality detection circuit 110 or the reception circuit 140 (for example, the abnormality detection circuit 110), and ignore the detection signal of another one thereof.

The transmission circuit 130 acquires the control signal from the control circuit 120, and operates in accordance with the control signal. The transmission circuit 130 transmits the detection result signal including the detection result of the abnormal state detected by the abnormality detection circuit 110 to another circuit (second charge/discharge control circuit 100-2) via the CNT terminal. In this manner, the charge/discharge control circuit 100 shares the detection result signal in the own circuit (first charge/discharge control circuit 100-1) with another circuit. The detection result signal may be an analog signal or a digital signal. The detection result signal provided by the abnormality detection circuit 110 and the transmitted/received detection result signal are only required to include the detection result, and may be expressed in formats different from each other or may include pieces of information different from each other.

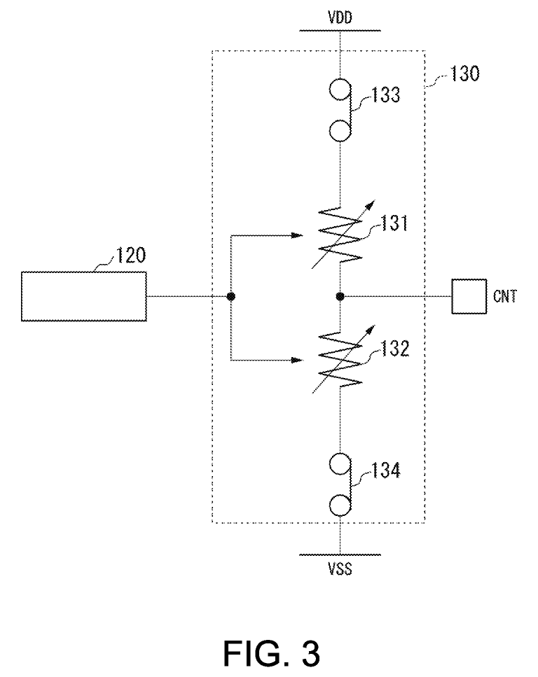

FIG. 3 is an explanatory diagram for illustrating a configuration example of the transmission circuit 130 in the first embodiment. The transmission circuit 130 includes, for example, a variable resistor 131, a variable resistor 132, a switch 133, and a switch 134.

The variable resistor 131 includes one end connected to the VDD terminal via the switch 133, and another end connected to one end of the variable resistor 132 and the CNT terminal. The variable resistor 132 includes another end connected to the VSS terminal via the switch 134, and the one end connected to the another end of the variable resistor 131 and the CNT terminal. A voltage at a connection point between the variable resistor 131 and the variable resistor 132 is determined by a ratio between a resistance value of the variable resistor 131 and a resistance value of the variable resistor 132. Further, the resistance values of the variable resistor 131 and the variable resistor 132 are determined in accordance with the control signal supplied from the control circuit 120. That is, the voltage supplied by the transmission circuit 130 is determined by a resistance ratio between the variable resistor 131 and the variable resistor 132, and consequently, a voltage ratio between the voltage of the VDD terminal and the voltage of the VSS terminal. In this manner, the detection result included in the detection result signal is expressed by the voltage ratio between the voltage of the VDD terminal and the voltage of the VSS terminal. The voltage ratio between the voltage of the VDD terminal and the voltage of the VSS terminal is a voltage ratio of the voltage of the detection result signal to a voltage between the VDD terminal and the VSS terminal. The detection result signal transmitted from the transmission circuit 130 is received by the reception circuit 140 of another circuit.

The reception circuit 140 receives the detection result signal including the detection result of the abnormality detection circuit 110 of the another circuit from the transmission circuit 130 of the another circuit. The reception circuit 140 supplies the received detection result signal to the control circuit 120. In this manner, the charge/discharge control circuit 100 shares the detection result signal in the another circuit with the own circuit.

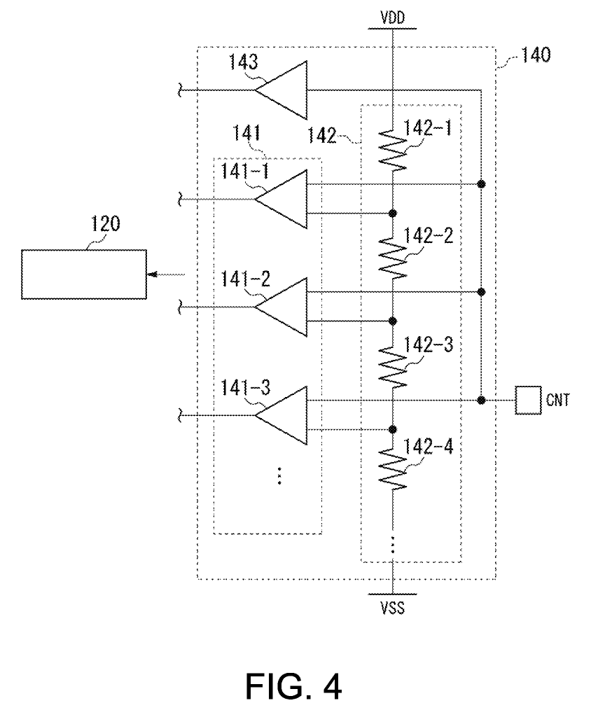

FIG. 4 is an explanatory diagram for illustrating a configuration example of the reception circuit 140 in the first embodiment. The reception circuit 140 includes, for example, a plurality of comparators 141, a plurality of resistors 142, and a threshold voltage detector 143. Comparators 141-1 to 141-3 are examples of the plurality of comparators 141. Resistors 142-1 to 142-4 are examples of the plurality of resistors 142. The plurality of resistors 142 are ladder resistors.

The comparator 141 is a comparator including a first input end to be supplied with the detection result signal of another circuit via the CNT terminal, and a second input end connected to the ladder resistor. The comparator 141 provides, from an output end thereof, a digital signal to the control circuit 120 based on a magnitude relationship between a voltage supplied to the first input end and a voltage supplied to the second input end. For example, the comparator 141 provides a signal of a high level (hereinafter referred to as “H” level in some cases) in a case in which the voltage ratio of the detection result signal is equal to or higher than a predetermined threshold, and provides a signal of a low level (hereinafter referred to as “L” level in some cases) in a case in which the voltage ratio is equal to or lower than the threshold. Specifically, a voltage obtained by dividing the voltage between the VDD terminal and the VSS terminal by a resistance ratio between the resistor 142-1 and a group of resistors including the resistor 142-2 and the subsequent resistors is supplied to the second input end of the comparator 141-1. A voltage obtained by dividing the voltage of the VDD terminal and the voltage of the VSS terminal by a resistance ratio between a group of the resistor 142-1 and the resistor 142-2 and a group of resistors including the resistor 142-3 and the subsequent resistors is supplied to the second input end of the comparator 141-2. The same applies to the comparator 141-3 and the subsequent comparators.

In this manner, the reception circuit 140 can determine the voltage ratio between the voltage of the VDD terminal and the voltage of the VSS terminal for the voltage supplied from the transmission circuit 130 of another circuit, and acquire the detection result in the another circuit. With the detection result included in the detection result signal being expressed by the voltage ratio, the detection result can be shared without being affected by the voltage value of the secondary battery VBAT that fluctuates depending on a usage status.

The voltage of the VDD terminal and the voltage of the VSS terminal are an example of transmission/reception with a common reference in the first charge/discharge control circuit 100-1 and the second charge/discharge control circuit 100-2, and the voltage of the VDD terminal and the voltage of the VSS terminal are not always required to be used. In the following, in some cases, a voltage on a high potential side such as the voltage of the VDD terminal is referred to as “first voltage,” and a voltage on a low potential side such as the voltage of the VSS terminal is referred to as “second voltage.”

The threshold voltage detector 143 includes an input end to be supplied with the detection result signal of another circuit via the CNT terminal, and an output end connected to the control circuit 120. The threshold voltage detector 143 provides a signal of the H level in a case in which the voltage of the detection result signal is equal to or higher than a predetermined threshold, and provides a signal of the L level in a case in which the voltage is equal to or lower than the threshold. Depending on a circuit configuration, in some cases, a range in which the comparator 141 can determine the voltage ratio is limited. With the threshold voltage detector 143, because a magnitude relationship can be determined even for a voltage based on a voltage ratio that is difficult to determine by the comparator 141, it is possible to increase the amount of information that can be included in the detection result signal.

The numbers of the comparators 141 and the threshold voltage detectors 143 may be determined in accordance with the number of types of abnormal states to be detected. For example, the numbers of the comparators 141 and the threshold voltage detectors 143 may be the same as the number of types of abnormal states to be detected.

In the description above, the charge/discharge control circuit 100 can grasp whether an abnormal state is detected in another circuit and the type of the detected abnormal state through transmission and reception of the detection result signal between the own circuit and the another circuit by the transmission circuit 130 and the reception circuit 140, and transition the control state of the own circuit and the control state of the another circuit to similar states. In the following, transitioning the control states to similar states is also referred to as “sharing the control state.” With the above-mentioned configuration, a situation in which one of the own circuit or the another circuit is in the protection state and another one thereof is in the normal state can be prevented. Thus, it is possible to avoid a situation in which protection of the secondary battery VBAT is hindered because one is in the protection state and the another is in the normal state. Further, with the control state being shared and each charge/discharge control circuit 100 performing similar control, it is possible to prevent a cell balance of the secondary battery VBAT controlled by each charge/discharge control circuit 100 from being lost. Accordingly, the charge/discharge control circuit 100 can suitably protect the secondary battery VBAT in a case of using two or more secondary batteries VBAT and two or more charge/discharge control circuits 100.

In the description above, the example in which the control circuit 120 provides the control signal to the transmission circuit 130 has been described. The first embodiment is not limited to this example, and the control circuit 120 may provide the detection result signal from the fourth end. In this case, the transmission circuit 130 operates in accordance with the detection result signal.

Further, in the description above, the example in which the detection result obtained by the abnormality detection circuit 110 is transmitted to the transmission circuit 130 via the control circuit 120 has been described. The first embodiment is not limited to this example, and the detection result signal including the detection result obtained by the abnormality detection circuit 110 may be directly supplied to the transmission circuit 130. Because the control circuit 120 originally has a configuration for providing a control signal to the DO terminal or the CO terminal for each control state, a configuration for providing a control signal to the transmission circuit 130 can be easily achieved. Further, with the control circuit 120 controlling the transmission circuit 130, the configuration of the transmission circuit 130 can be simplified.

### Second Embodiment

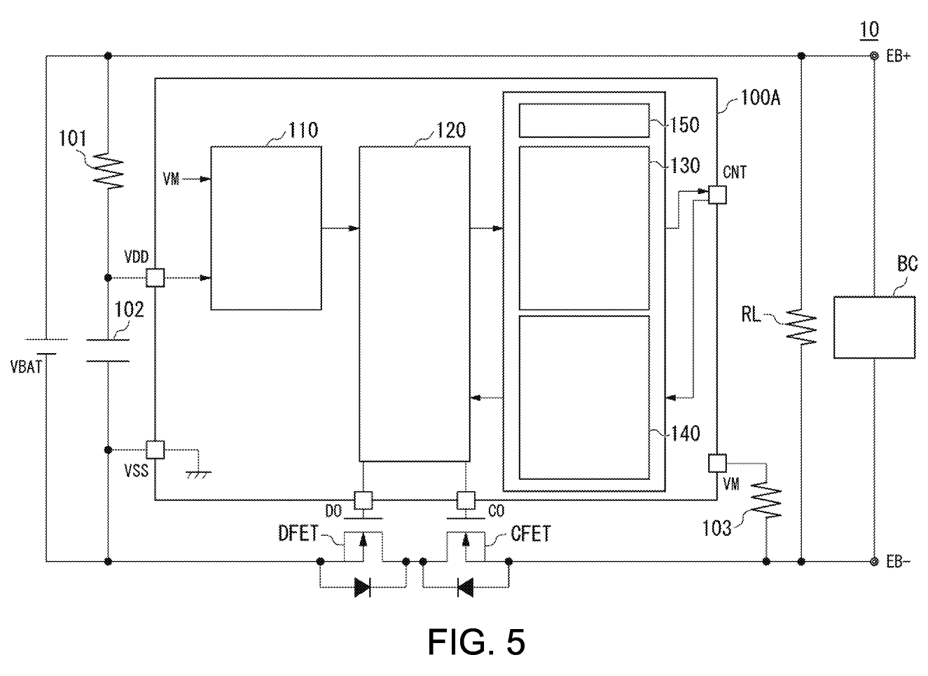

FIG. 5 is an explanatory diagram for illustrating a configuration example of a charge/discharge control circuit 100A according to a second embodiment of the present invention. The charge/discharge control circuit 100A according to the second embodiment is different from the charge/discharge control circuit 100 according to the first embodiment in that the charge/discharge control circuit 100A further includes a constant voltage source 150. In the following description, description of the matters described in the first embodiment may be omitted.

The constant voltage source 150 is a power supply circuit for supplying a stable output voltage regardless of fluctuations in the voltage value of the secondary battery VBAT. The constant voltage source 150 may be, for example, a low dropout (LDO) regulator. The voltage provided from the constant voltage source 150 is supplied to the transmission circuit 130 and the reception circuit 140 instead of the voltage between the VDD terminal and the VSS terminal. With this configuration, the transmission circuit 130 and the reception circuit 140 can transmit and receive the detection result signal expressing the detection result by a voltage value. In a case of expressing the detection result by the voltage value, it is not required to use a circuit having a large output current value because the receiving side has high impedance. Accordingly, an element having a small area can be adopted for the constant voltage source 150, and the area of the charge/discharge control circuit 100A can be reduced.

### Third Embodiment

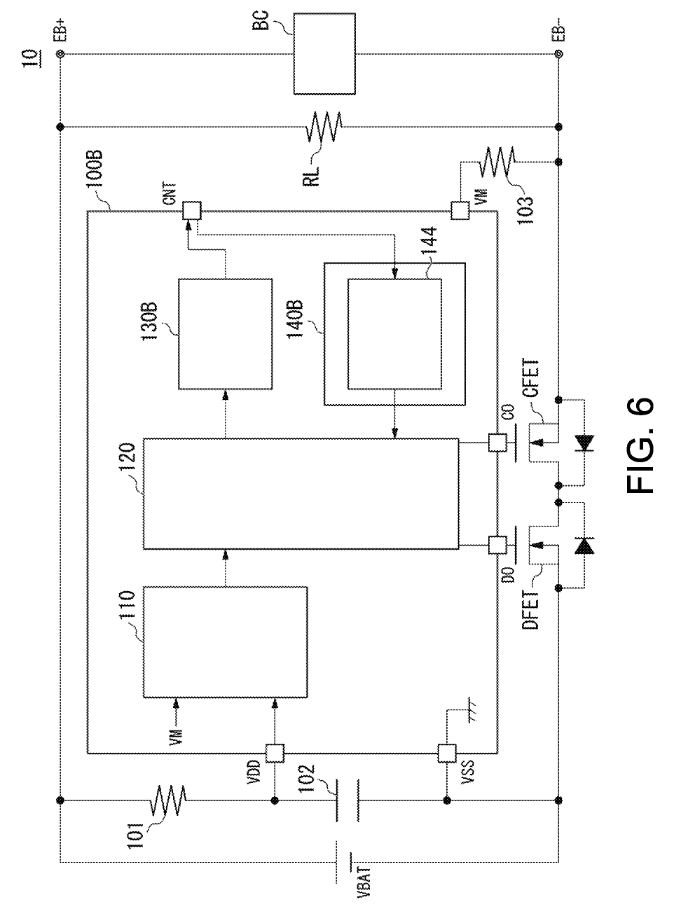

FIG. 6 is an explanatory diagram for illustrating a configuration example of a charge/discharge control circuit 100B according to a third embodiment of the present invention. The charge/discharge control circuit 100B according to the third embodiment is different from the charge/discharge control circuit 100 according to the first embodiment in that the detection result is expressed by a duty ratio of a pulse.

A transmission circuit 130B included in the charge/discharge control circuit 100B generates a waveform having a duty ratio corresponding to the detection result, and supplies the waveform to another circuit. The transmission circuit 130B is achieved by, for example, pulse width modulation (PWM) or pulse frequency modulation (PFM).

A reception circuit 140B included in the charge/discharge control circuit 100B includes a smoothing circuit 144. The reception circuit 140B receives the detection result signal received from the another circuit, and supplies the detection result signal to the smoothing circuit 144. The smoothing circuit 144 converts the supplied voltage into a DC voltage by smoothing the waveform of the supplied voltage. The voltage smoothed by the smoothing circuit 144 has a magnitude corresponding to the duty ratio of the waveform before conversion. The reception circuit 140B determines the detection result included in the detection result signal based on the voltage value after smoothing. With the detection result being expressed by the duty ratio, an influence of noise at the time of transmission and reception can be reduced as compared with a case in which the detection result is expressed by the magnitude of the voltage value. Accordingly, the charge/discharge control circuit 100B can appropriately share the control state.

### Fourth Embodiment

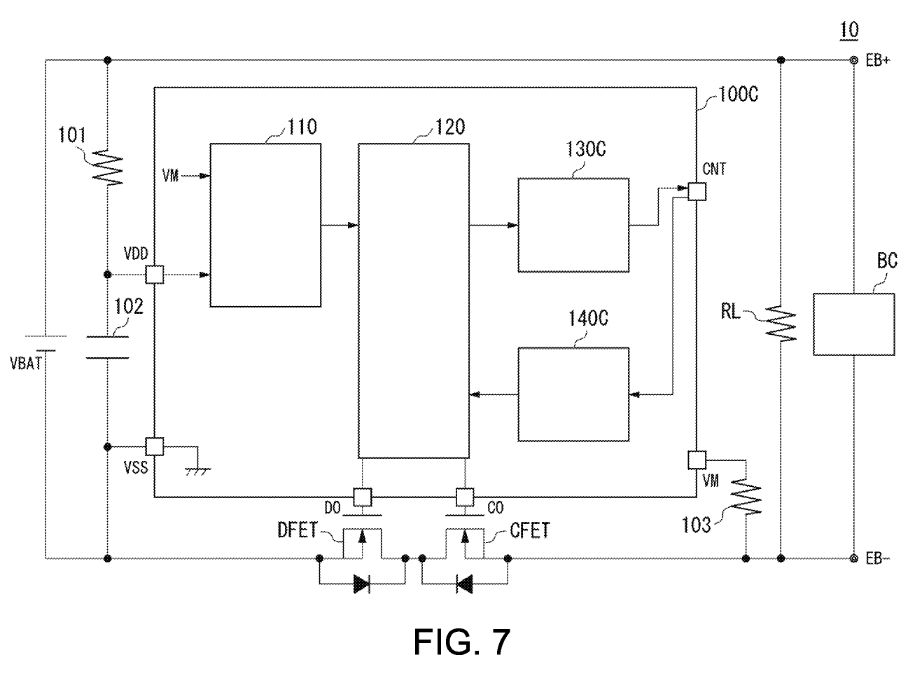

FIG. 7 is an explanatory diagram for illustrating a configuration example of a charge/discharge control circuit 100C according to a fourth embodiment of the present invention. The charge/discharge control circuit 100C according to the fourth embodiment is different from the charge/discharge control circuit 100 according to the first embodiment in that the detection result is expressed by a pulse width. Further, the charge/discharge control circuit 100C is different from the charge/discharge control circuit 100B according to the third embodiment in that the supplied detection result signal is not returned to an analog signal.

A transmission circuit 130C included in the charge/discharge control circuit 100C generates a waveform having a pulse width corresponding to the detection result, and supplies the waveform to another circuit. The transmission circuit 130C is achieved by, for example, PFM. A reception circuit 140C included in the charge/discharge control circuit 100C may be a pulse width (PW) determination circuit for determining the pulse width of the waveform of the voltage supplied from the transmission circuit 130C of another circuit. With using no smoothing circuit 144 or the like, time required for smoothing can be reduced, and the detection result signal can be transmitted and received faster.

In a case in which the transmission circuit 130C is PFM, the reception circuit 140C is not required to include the smoothing circuit 144. For example, the reception circuit 140C may include a bandpass filter for passing a specific frequency band for each abnormal state to be detected, and determine the detection result based on which bandpass filter the voltage has passed through. With the frequency band to be included being adjusted, the presence or absence of detection for each type of abnormal state can be included in the detection result signal and transmitted or received.

The charge/discharge control circuits according to the first embodiment to the fourth embodiment described above can all be achieved with one terminal. Specifically, transmission by the transmission circuit 130 and reception by the reception circuit 140 are performed by the same signal line (signal line connecting the CNT terminals). The CNT terminal is a terminal that may be conventionally provided in the charge/discharge control circuit 100 to control an external circuit or the like. According to the charge/discharge control circuit 100 capable of sharing the control state without increasing the number of terminals from the CNT terminal, the area of the charge/discharge control circuit 100 can be reduced. Further, because the number of terminals does not change, it is not required to redraw a pattern newly, and labor for mounting the battery device 10 according to the embodiment, and the like is reduced. In a case in which transmission by the transmission circuit 130 and reception by the reception circuit 140 are performed by the same signal line, there is a possibility that the reception circuit 140 receives the detection result signal transmitted by the transmission circuit 130 to cause a malfunction. Accordingly, it is desired that the reception circuit 140 be prevented from performing reception at the time of transmission by the transmission circuit 130. The phrase “the reception circuit 140 is prevented from performing reception” may mean that power supply to the reception circuit 140 is interrupted at the time of transmission, that the reception circuit 140 does not provide the received detection result to the control circuit 120, or that the control circuit 120 does not transition to a control state in accordance with the detection result provided from the reception circuit 140. Further, interference may be avoided by scheduling transmission timing and reception timing in advance.

### Fifth Embodiment

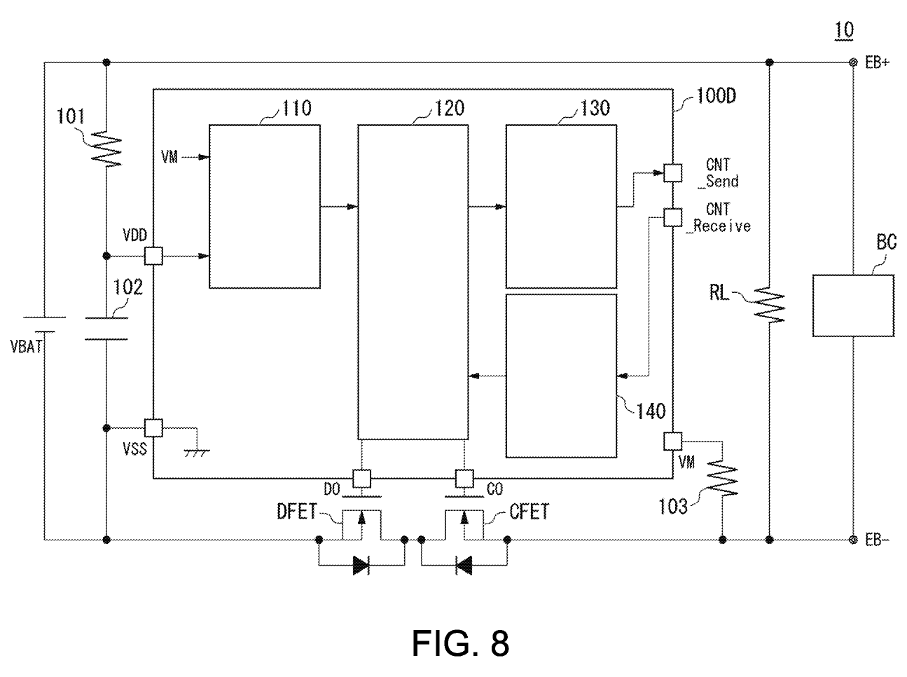

FIG. 8 is an explanatory diagram for illustrating a configuration example of a charge/discharge control circuit 100D according to a fifth embodiment of the present invention. The charge/discharge control circuit 100D according to the fifth embodiment is different from the charge/discharge control circuit 100 according to the first embodiment in that transmission of the detection result signal by the transmission circuit 130 and reception of the detection result signal by the reception circuit 140 are performed by mutually different signal lines.

The charge/discharge control circuit 100D includes a CNT_Send terminal and a CNT_Receive terminal instead of the CNT terminal. The CNT_Send terminal is connected to the transmission circuit 130, and the CNT_Receive terminal is connected to the reception circuit 140. The transmission circuit 130 transmits the detection result signal using a signal line connecting the CNT_Send terminal of the own circuit and the CNT_Receive terminal of another circuit. Further, the reception circuit 140 receives the detection result signal using a signal line connecting the CNT_Receive terminal of the own circuit and the CNT_Send terminal of the another circuit. According to the charge/discharge control circuit 100D that performs transmission and reception using separate independent signal lines, interference between the transmitted detection result signal and the received detection result signal can be avoided. Further, because no scheduling or the like for avoiding interference is required, the detection result signal can be shared faster.

### Sixth Embodiment

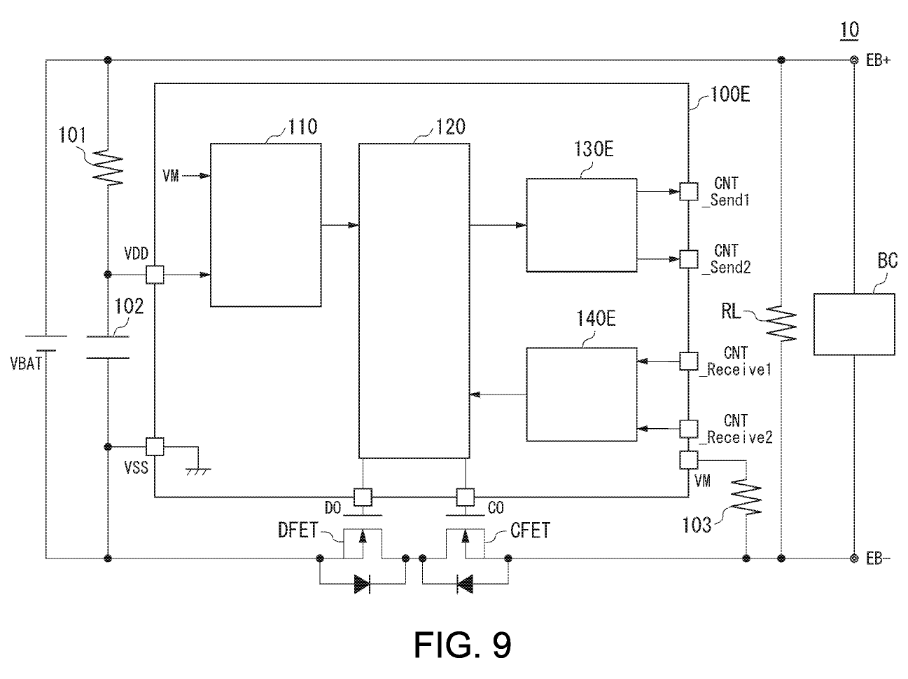

FIG. 9 is an explanatory diagram for illustrating a configuration example of a charge/discharge control circuit 100E according to a sixth embodiment of the present invention. The charge/discharge control circuit 100E according to the sixth embodiment is different from the charge/discharge control circuit 100D according to the fifth embodiment in that the detection result signal is transmitted and received using a binary signal.

The charge/discharge control circuit 100E includes a CNT_Send1 terminal and a CNT_Send2 terminal instead of the CNT_Send terminal. Further, the charge/discharge control circuit 100E includes a CNT_Receive1 terminal and a CNT_Receive2 terminal instead of the CNT_Receive terminal. A transmission circuit 130E included in the charge/discharge control circuit 100E converts the detection result into a binary signal and transmits the binary signal to another circuit via the CNT_Send1 terminal and the CNT_Send2 terminal. Further, a reception circuit 140E included in the charge/discharge control circuit 100E receives the binary signal transmitted from the another circuit via the CNT_Receive1 terminal and the CNT_Receive2 terminal, and determines the detection result in the another circuit from the binary signal. In a case of expressing the detection result by an analog signal, it takes time until a current flows through the signal line and the voltage switches. According to the charge/discharge control circuit 100E that transmits and receives the detection result signal through use of the binary signal (digital signal), the detection result signal can be shared faster. Further, because the charge/discharge control circuit 100E is resistant to noise as compared with a case of transmission and reception using an analog signal, the detection result signal can be shared appropriately. The number of terminals included in the charge/discharge control circuit 100E is merely an example, and may be a number corresponding to the number of types of abnormal states to be detected. For example, the charge/discharge control circuit 100E may perform transmission or reception by a serial signal of 1 bit (1 terminal), or may perform transmission or reception by a parallel signal of a plurality of bits (plurality of terminals). With the number of terminals used for transmission or reception being set to a number corresponding to the number of types of abnormal states or half thereof, all detection results can be shared at once.

### Seventh Embodiment

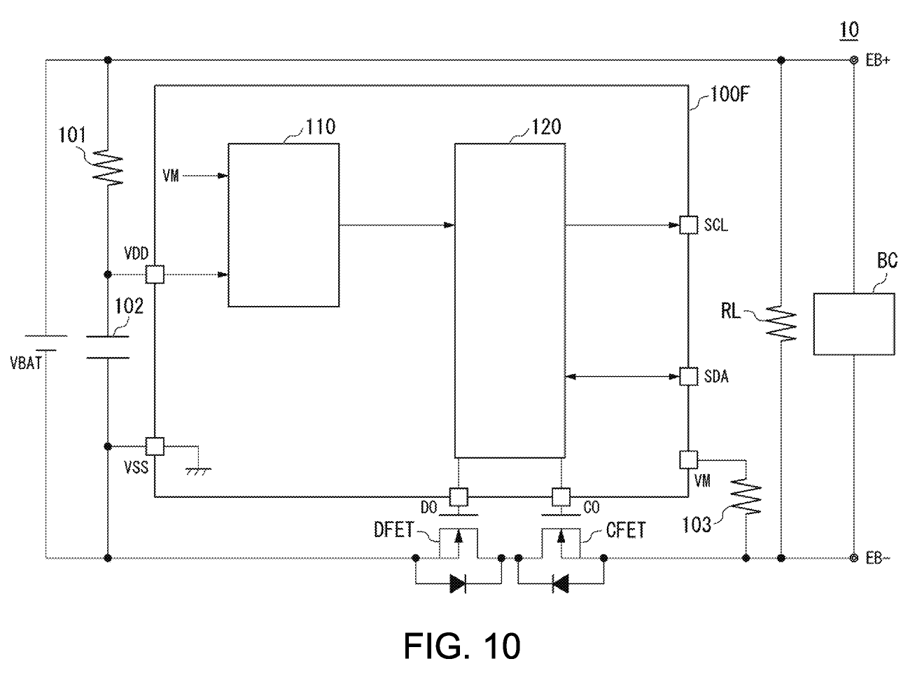

FIG. 10 is an explanatory diagram for illustrating a configuration example of a charge/discharge control circuit 100F according to a seventh embodiment of the present invention. The charge/discharge control circuit 100F according to the seventh embodiment is different from the charge/discharge control circuit 100 according to the first embodiment in that a communication standard of Inter-Integrated Circuit (I2C) is used for transmission and reception of the detection result signal.

The charge/discharge control circuit 100F does not include the transmission circuit 130 and the reception circuit 140. Further, the charge/discharge control circuit 100F includes an SCL terminal and an SDA terminal instead of the CNT_Send terminal and the CNT_Receive terminal. The control circuit 120 is connected to the SCL terminal and the SDA terminal. The SCL terminal is connected to a signal line for providing a clock signal. The SDA terminal is connected to a signal line for transmitting and receiving the detection result signal. In the communication standard of I2C, a master controls communication timing. Thus, interference of transmission and reception of the detection result signal between the charge/discharge control circuits 100F can be avoided. According to the charge/discharge control circuit 100F using the communication standard of I2C, interference can be easily avoided. Thus, the battery system 1 including three or more charge/discharge control circuits 100F can be easily achieved without constructing a complicated system. FIG. 10 shows an example in which the charge/discharge control circuit 100F is a slave, and a device corresponding to the master is mounted outside the charge/discharge control circuit 100F. The seventh embodiment is not limited to this example, and a circuit operating as a master may be mounted inside any of the charge/discharge control circuit 100F or the control circuit 120 included in the battery system 1.

Although at least one embodiment of the present invention has been described above in detail with reference to the drawings, the specific configuration is not limited to the above, and various design changes and the like can be made without departing from the gist of the present invention. The at least one embodiment is not limited to those embodiments, and includes those to which various changes or improvements are added. That is, the components described below include components that can be easily assumed by those skilled in the art and components that are substantially the same, and the components described in the respective embodiments and examples described above can be combined as appropriate. Further, in the at least one embodiment, various omissions, substitutions, or changes of components may be made without departing from the gist of the present invention.

In the description above, the resistor 103 and the external FET 104 are arranged on a low side (negative electrode side of the battery), but the arrangement is not limited thereto, and the resistor 103 and the external FET 104 may be arranged on a high side (positive electrode side of the battery).

What is claimed is:

1. A charge/discharge control circuit, comprising a control circuit configured to transition to a control state corresponding to a detection result of an abnormal state, and perform open/close control of a charge/discharge path of one or a plurality of secondary batteries being a control target in accordance with the control state,
wherein the charge/discharge control circuit is connected in parallel to an external terminal provided in the charge/discharge path, and is configured to transmit and receive a detection result signal including the detection result to and from another charge/discharge control circuit having, as a control target, one or a plurality of secondary batteries different from the one or the plurality of secondary batteries of an own circuit, to thereby transition the control state of the own circuit and the control state of the another charge/discharge control circuit to similar states.

2. The charge/discharge control circuit according to claim 1, further comprising:
a transmission circuit configured to transmit the detection result signal to the another charge/discharge control circuit; and
a reception circuit configured to receive the detection result signal including the detection result in the another charge/discharge control circuit from the another charge/discharge control circuit,
wherein transmission by the transmission circuit and reception by the reception circuit are performed by the same signal line, and
wherein the reception circuit is prevented from performing reception in a case in which the transmission circuit performs transmission.

3. The charge/discharge control circuit according to claim 2, wherein the detection result included in the detection result signal is expressed by a voltage ratio between a first voltage and a second voltage.

4. The charge/discharge control circuit according to claim 2,
wherein the transmission circuit is configured to supply a voltage having a duty ratio corresponding to the detection result, and
wherein the reception circuit further includes a smoothing circuit configured to smooth the supplied voltage, and is configured to determine the detection result based on a voltage value after smoothing.

5. The charge/discharge control circuit according to claim 2,
wherein the transmission circuit is configured to supply a voltage of a waveform having a pulse width corresponding to the detection result, and
wherein the reception circuit is configured to determine the detection result in accordance with the pulse width of the supplied voltage.

6. The charge/discharge control circuit according to claim 1, further comprising:
a transmission circuit configured to transmit the detection result signal to the another charge/discharge control circuit; and
a reception circuit configured to receive the detection result signal including the detection result in the another charge/discharge control circuit from the another charge/discharge control circuit,
wherein transmission by the transmission circuit and reception by the reception circuit are performed by mutually different signal lines.

7. The charge/discharge control circuit according to claim 6,
wherein the transmission circuit is configured to convert the detection result into a binary signal and transmit the binary signal, and
wherein the reception circuit is configured to determine the detection result based on the received binary signal.

8. The charge/discharge control circuit according to claim 1, wherein the detection result signal is transmitted and received through use of a communication standard of Inter-Integrated Circuit (I2C).

9. A charge/discharge control device, comprising:
the charge/discharge control circuit of claim 1;
a charge control transistor provided in the charge/discharge path, the charge control transistor including a gate connected to a charge control terminal of the control circuit; and
a discharge control transistor provided in the charge/discharge path, the discharge control transistor including a gate connected to a discharge control terminal of the control circuit.

10. A battery device, comprising:
the charge/discharge control device according to claim 9; and
the one or the plurality of secondary batteries.

11. A battery system, comprising a plurality of the charge/discharge control circuits of claim 1 connected in parallel to the external terminal.
